(19) United States
(12) Patent Application Publication
(10) Pub. No.: US 2026/0024792 A1
(43) Pub. Date: Jan. 22, 2026

(54) FUEL CELL SYSTEM AND A METHOD OF CONTROLLING THE SAME

(71) Applicants: HYUNDAI MOTOR COMPANY, Seoul (KR); KIA CORPORATION, Seoul (KR)

(72) Inventor: Min Gu Park, Hwaseong-si (KR)

(73) Assignees: HYUNDAI MOTOR COMPANY, Seoul (KR); KIA CORPORATION, Seoul (KR)

(21) Appl. No.: 18/961,051

(22) Filed: Nov. 26, 2024

(30) Foreign Application Priority Data
Jul. 16, 2024 (KR) 10-2024-0093895

(51) Int. Cl. H01M 8/04992; H01M 8/04537

(52) U.S. Cl. CPC H01M 8/04992; H01M 8/04589; H01M 2250/20

(57) ABSTRACT

A fuel cell system and a method of controlling the same are provided. The fuel cell system includes a second controller that transmits a total control command for satisfying a total required control amount of the plurality of modules to at least one control target controller among a plurality of identified first controllers based on an identification result of the plurality of identified first controllers. The at least one control target controller individually controls a corresponding fuel cell module in response to the total control command.

### CROSS REFERENCE TO RELATED APPLICATION

This application claims priority to Korean Patent Application No. 10-2024-0093895, filed on Jul. 16, 2024, the entire contents of which are incorporated herein by reference.

### TECHNICAL FIELD

The present disclosure relates to a fuel cell system that controls a plurality of fuel cell modules based on wireless communication, and a method of controlling the same.

### BACKGROUND

A fuel cell vehicle generally uses a fuel cell system which includes: a fuel cell stack for generating electric power through an electrochemical reaction between fuel and an oxidizer, a fuel supply device for supplying a fuel gas to an anode of the fuel cell stack through a fuel gas supply path; and an air supply device for supplying oxygen-containing air to a cathode of the fuel cell stack through an oxidizing gas supply path. The fuel cell system further includes: a thermal management device for controlling an operating temperature of the fuel cell stack; and a control device for controlling an operation of the fuel cell system.

In this fuel cell system, hydrogen that is the fuel is oxidized at the anode (oxidation electrode) of the stack and therefore hydrogen ions and electrons are generated. The hydrogen ions of the anode pass through an electrolyte membrane and move to the cathode (deoxidation electrode), and oxygen is reduced to generate water. In this case, the electrons move from the anode to the cathode through an external conducting wire, generating electrical energy.

When the fuel cell system is applied to a target requiring a high output, such as a ship or power generation, the fuel cell system can be configured with a plurality of fuel cell modules sharing an output to secure the required output. In this case, each fuel cell module is controlled by each low-level controller, and a high-level controller controls the overall fuel cell modules by controlling each lower-level controller, which increases communication complexity between the high-level and low-level controllers and may cause mechanical constraints in the interconnection.

The foregoing is intended merely to aid in the understanding of the background of the present disclosure, and is not intended to mean that the present disclosure falls within the purview of the related art that is already known to those having ordinary skill in the art.

### SUMMARY

The present disclosure has been made keeping in mind the above problems occurring in the related art. The present disclosure provides a fuel cell system that performs distribution control on a plurality of fuel cell modules through wireless communication between high-level and low-level controllers, thereby improving control efficiency and system expandability, and a method of controlling the same.

It should be noted that objects of the present disclosure are not limited to the above-described objects, and other objects of the present disclosure should be apparent to those having ordinary skill in the art from the following descriptions.

According to one aspect, a fuel cell system includes a plurality of first controllers configured to control a plurality of fuel cell modules, and a second controller configured to control the plurality of fuel cell modules through wireless communication with the plurality of first controllers. The second controller transmits a total control command for satisfying a total required control amount of the plurality of fuel cell modules to at least one target controller among a plurality of identified first controllers based on an identification result of the plurality of identified first controllers. The at least one target controller individually controls a corresponding fuel cell module among the plurality of fuel cell modules in response to the total control command.

According to another aspect, a method of controlling a fuel cell system includes: identifying, by a second controller, a plurality of first controllers through wireless communication with the plurality of first controllers configured to control a plurality of fuel cell modules; transmitting, by the second controller, a total control command for satisfying a total required control amount of the plurality of fuel cell modules to at least one target controller among a plurality of identified first controllers based on an identification result of the plurality of identified first controllers; and individually controlling, by the at least one target controller, a corresponding fuel cell module among the plurality of fuel cell modules in response to the total control command.

### BRIEF DESCRIPTION OF THE DRAWINGS

The accompanying drawings are intended to aid understanding of embodiments of the present disclosure and provide embodiments along with detailed descriptions. However, the technical features of these embodiments are not limited to specific drawings, and the features disclosed in each drawing may be combined to form a new embodiment, in which:

FIG. 1 is a diagram illustrating a configuration of a fuel cell system according to an embodiment of the present disclosure;

FIGS. 2 and 3 are diagrams for describing a method of performing distribution control on a plurality of fuel cell modules according to embodiments of the present disclosure;

FIG. 4 is a flowchart for describing a controller identification process according to an embodiment of the present disclosure; and

FIG. 5 is a flowchart for describing an operation process of the plurality of fuel cell modules according to an embodiment of the present disclosure.

### DETAILED DESCRIPTION

Specific structural and functional descriptions of embodiments of the present disclosure disclosed in this disclosure or application are illustrative only for the purpose of describing embodiments, and embodiments according to the present disclosure may be implemented in various forms and should not be construed as being limited to embodiments described in the present specification or application.

Embodiments according to the present disclosure may be variously modified and may have various forms, so that specific embodiments are illustrated in the drawings and described in detail in the present specification or application. It should be understood, however, that it is not intended to limit embodiments according to the concept of the present disclosure to specific disclosure forms, but it includes all modifications, equivalents, and alternatives falling within the spirit and scope of the present disclosure.

Unless defined otherwise, all terms including technical or scientific terms used herein have the same meaning as commonly understood by those having ordinary skill in the art to which the present disclosure pertains. General terms that are defined in a dictionary shall be construed to have meanings that are consistent in the context of the relevant art and should not be interpreted as having an idealistic or excessively formalistic meaning unless clearly defined in the present specification.

Hereinafter, embodiments disclosed in the present specification are described in detail with reference to the drawings. The same reference numerals are given to the same or similar components regardless of reference numerals, and a repetitive description thereof has been omitted.

In the description of the following embodiments, the term “preset” means that a value of a parameter is predetermined when using the parameter in a process or algorithm. Depending on an embodiment, the value of the parameter may be set when a process or algorithm starts or may be set during a section in which the process or algorithm is performed.

As used in the following description, suffixes “module” and “part” for a component are used or interchangeably used solely for ease of preparation of the specification, and do not have different meanings and each of them does not function by itself.

In describing embodiments disclosed in the present specification, when a detailed description of a known related art is determined to obscure the gist of the present specification, the detailed description thereof has been omitted herein. In addition, the accompanying drawings are merely for easy understanding of embodiments disclosed in the present specification. The technical spirit disclosed in the present specification is not limited by the accompanying drawings. It should be understood to include all modifications, equivalents, and substitutes included in the spirit and scope of the present disclosure.

Terms including ordinal numbers such as first, second, and the like used herein may be used to describe various components, but the various components are not limited by these terms. The terms are used only for the purpose of distinguishing one component from another component.

When a component is referred to as being “connected” or “coupled” to another component, the component may be directly connected or coupled to another component, but it should be understood that still another component may be present between the component and another component. Conversely, when a component is referred to as being “directly connected” or “directly coupled” to another, it should be understood that still another component may not be present between the component and another component.

Unless the context clearly dictates otherwise, the singular form includes the plural form.

In the present specification, the terms “comprising,” “having,” “including,” or the like are used to specify that a feature, a number, a step, an operation, a component, an element, or a combination thereof described herein exists, and they do not preclude the presence or addition of one or more other features, numbers, steps, operations, components, elements, or combinations thereof.

In addition, a unit or a control unit included in the names of a vehicle control unit (VCU), a fuel cell control unit (FCU), and the like is a term widely used in the naming of a controller that controls a specific vehicle function and does not refer to a generic function unit.

For example, a controller may include a communication device for communicating with other control units or sensors to control a responsible function, a memory for storing an operating system, a logic command, and input/output information, and one or more processors for performing determination, calculation, and decision which are necessary for controlling the responsible function.

When a component, unit, module, controller, device, element, apparatus, or the like of the present disclosure is described as having a purpose or performing an operation, function, or the like, the component, unit, module, controller, device, element, apparatus, or the like should be considered herein as being “configured to” meet that purpose or to perform that operation or function.

The term “unit” or “module” used in this specification signifies one unit that processes at least one function or operation, and may be realized by hardware, software, or a combination thereof. The operations of the method or the functions described in connection with the forms disclosed herein may be embodied directly in a hardware or a software module executed by a processor, or in a combination thereof.

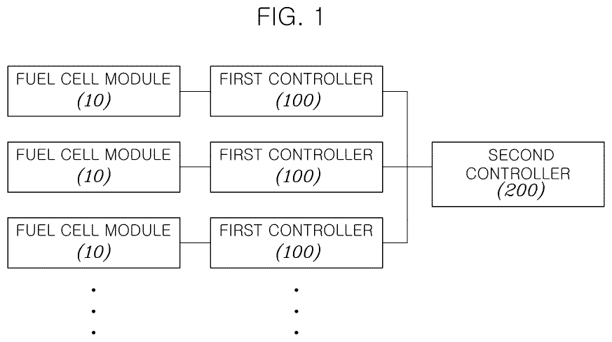

FIG. 1 is a diagram illustrating a configuration of a fuel cell system according to an embodiment of the present disclosure.

Referring to FIG. 1, the fuel cell system according to an embodiment of the present disclosure includes a plurality of first controllers 100 for controlling a plurality of fuel cell modules 10, and a second controller 200 for controlling the plurality of fuel cell modules 10 through wireless communication with the plurality of first controllers 100. The number of the fuel cell modules 10 and the first controllers 100 constituting the system may be selected in various ways, and the number of the first controllers 100 and the number of the fuel cell modules 10 correspond to each other, but do not necessarily have to be the same.

In addition, the first controller 100 may be implemented as an FCU for controlling the fuel cell module, and the second controller 200 may be implemented as a high-level controller such as a VCU for controlling the FCU.

Prior to controlling the fuel cell modules 10, the second controller 200 may identify the plurality of first controllers 100 based on wireless communication and transmit a total control command for satisfying a total required control amount of the plurality of fuel cell modules 10 to at least one control target controller among the identified plurality of first controllers 100 based on the result of the identification. As used herein, the control target controller may be referred to as a target controller.

The at least one control target controller individually controls a corresponding fuel cell module 10 among the plurality of fuel cell modules 10 based on the total control command received from the second controller 200.

The at least one control target controller may be a first controller 100, among the identified plurality of first controllers 100, which is in a state capable of controlling the corresponding fuel cell module 10. The second controller may identify the first controller through the wireless communication, thereby confirming a fuel cell module which is available for an operation of the system and transmitting the total control command to the first controller 100 for individual control of the fuel cell modules.

The total control command of the second controller 200 may include information of the total required control amount and the number of operable fuel cell modules among the plurality of fuel cell modules.

The total required control amount may be, for example, total required power. The second controller 200 may determine the number of operable fuel cell modules based on wireless communication responses from the identified plurality of first controllers 100.

Each control target controller receiving the total control command may individually control the corresponding fuel cell module 10 to follow a target control amount for each module determined based on the total required control amount and the number of operable fuel cell modules, which are included in the command.

For example, the target control amount for each module may be determined as a value obtained by dividing the total required control amount by the number of operable fuel cell modules.

During the individual control of each fuel cell module 10 as described above, the second controller 200 may acquire a current control amount for each module from at least one control target controller and monitor whether the total required control amount is satisfied based on the sum of obtained current control amounts for the modules and the number of operable fuel cell modules.

In other words, the second controller 200 may determine whether the sum of the current control amounts for the modules, which is an actual control amount according to the operation of each fuel cell module, satisfies the total required control amount.

As the monitoring result, when the total required control amount is not satisfied, the second controller 200 may transmit an additional control command, which includes an error between the sum of the current control amounts for the modules and the total required control amount and the number of operable fuel cell modules, to at least one control target controller, and the at least one control target controller receiving the additional control command individually controls a corresponding fuel cell module in response to the additional control command.

The at least one control target controller may perform individual control on each fuel cell module to follow a correction amount for each module, which is determined based on the error between the sum of the current control amounts for the modules, the total required control amount, and the number of the operable fuel cell modules. The correction amount for each module may be determined, for example, as a value obtained by dividing the error between the sum of the current control amounts for the modules and the total required control amount by the number of operable fuel cell modules.

Furthermore, the additional control command may further include information of the number of fuel cell modules not following the command among the plurality of fuel cell modules determined based on the target control amount for each module and the current control amount for each module. In this case, the correction amount for each module may be determined by further considering the number of fuel cell modules not following the command.

For example, the number of fuel cell modules, each whose the target control amount for each module and the current control amount for each module do not match, may be determined as the number of fuel cell modules not following the command. The correction amount for each module may be determined as a value obtained by dividing a subtracted number, which is obtained by subtracting the number of fuel cell modules not following the command from the quantity of operable fuel cell modules, by the error between the sum of the current control amounts for the modules and the total required control amount.

In addition, the additional control command may further include a slew rate determined based on the error between the sum of the current control amounts for the modules and the total required control amount, and the slew rate may be determined by further considering the operating situations of the plurality of fuel cell modules 10.

The slew rate may be understood as a following speed for the command, and the higher the slew rate, the faster the total required control amount may be satisfied, and the lower the slew rate, the slower the total required control amount may be satisfied.

In addition, the operating situation of the fuel cell module 10 may include, for example, when the total required control amount corresponds to an output amount, 1) a situation in which the fuel cell module is used as the main power source and immediate satisfaction of the total required output amount is required, 2) a situation in which regenerative braking is applied and the output amount changes frequently, 3) a situation in which a separate power source is used together or stored power is sufficient, and 4) a situation in which the output amount hardly changes and output safety has a high priority. The slew rate may vary depending on each operating situation. In the above example, the slew rates according to situations 1) and 2) may have values that are higher than the slew rates according to situations 3) and 4).

The second controller 200 may receive first identification information randomly generated from each of the plurality of first controllers 100 and may identify the plurality of first controllers 100 by mapping the first identification information and a location of the first controller 100 generating the first identification information.

In addition, the second controller 200 may transmit the mapping result to each of the first controllers 100 corresponding to the mapping result and may also identify the plurality of first controllers 100 based on a response of at least one first controller 100 receiving the mapping result. In this case, when there is no response from the first controller 100 receiving the mapping result, identification may be considered as being failed and performed again.

The first controller 100 receiving the mapping result may at least identify itself, and depending on implementation, the first controller 100 may also identify other first controllers 100.

In addition, the second controller 200 may assign second identification information with a unique value for each mapping result with respect to the mapping result and may identify each first controller 100 according to the assigned second identification information.

Each of the plurality of first controllers 100 may transmit the first identification information, which is generated itself, to the remaining first controllers 100 except itself. When at least one of the first identification information received from the remaining first controllers 100 overlaps the first identification information generated by itself, the first identification information may be regenerated to prevent the second controller 200 from duplicately identifying the plurality of first controllers 100.

In addition, the duplicate identification prevention may be performed by requesting retransmission to each of the first controllers 100 transmitting the duplicated first identification information when there is the duplicated first identification information among the first identification information received by the second controller 200.

This duplicate identification prevention may be performed by both the first controller 100 and the second controller 200. Alternatively, the duplicate identification prevention may also be implemented to be performed only in the second controller 200 or only in the first controller 100.

The second controller 200 may perform wireless communication by transmitting and receiving signals to and from the plurality of first controllers 100 through a frequency with a bandwidth that is greater than or equal to a preset range. The wireless communication may be ultra-wide band (UWB) wireless communication, and as communication between the first controller 100 and the second controller 200 is performed as described above, a large amount of information may be transmitted at low power over a wide band, the wireless communication may be robust against interference such as a noise to be advantageous in terms of distance measurement, thereby effectively responding to external attacks such as hacking based on fast communication performance and accurate distance measurement performance.

In addition, the second controller may determine the location of each of the plurality of first controllers 100 based on a transmission and reception time of a signal and, for example, the location determination may be performed in a time of flight (TOF) manner.

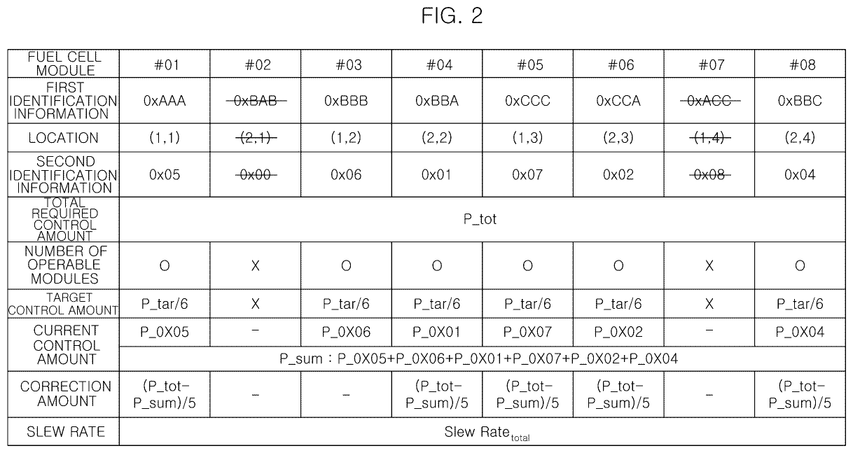

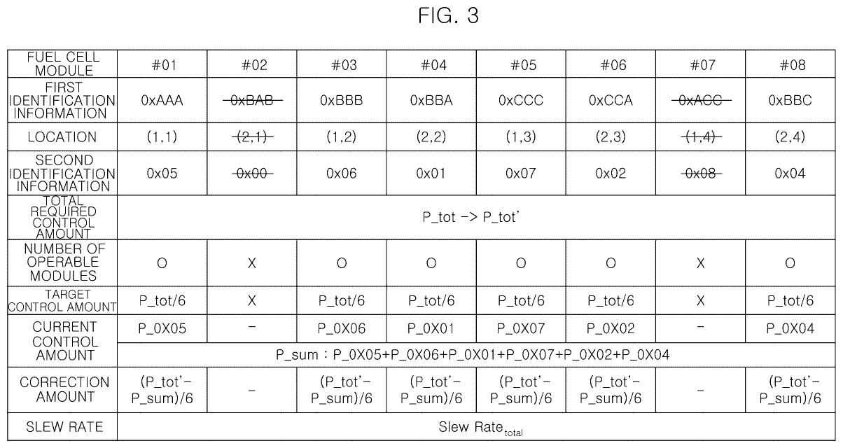

FIGS. 2 and 3 are diagrams (i.e., tables) for describing a method of performing distribution control on a plurality of fuel cell modules according to embodiments of the present disclosure.

First, FIG. 2 shows an example in which a control amount of each module 10 during normal operation increases as a command non-following module occurs during the distribution control of the fuel cell module 10. The command non-following module may be defined as a module that does not meet a target control amount for each module among the plurality of fuel cell modules 10. For example, the command non-following module may be the fuel cell module 10 with a trouble outputting to meet the target control amount, such as when cooling water of a corresponding module is out of a normal temperature range, a pressure of hydrogen being supplied is insufficient compared to a pressure required for power generation, or power generation performance is reduced due to deterioration.

First, each first controller 100 may transmit arbitrary first identification information (0XAAA, 0XBAB, and 0XBBB) to the second controller 200, and the second controller 200 receiving the first identification information may map the first identification information and a location of the first controller 100 transmitting the first identification information and assign unique second identification information to each mapping result to identify each first controller 100. For example, a fuel cell module #01 may be identified as “0X05” and its corresponding location may be seen as (1,1).

The second controller 200 transmits a total control command including a total required control amount (P_tot) and the number of operable fuel cell modules to the control target controller. In an example of FIG. 2, the control target controllers are 0X05, 0X06, 0X01, 0X07, 0X02, and 0X04 which correspond to fuel cell modules #01, #03, #04, #05, #06, and #08, respectively.

Each control target controller receiving the total control command individually controls the corresponding fuel cell module 10 to follow the target control amount for each module P_tot/6 according to the total required control amount P_tot and the number of operable fuel cell modules (=‘6’).

During the individual control process, the second controller 200 may continuously monitor whether the total required control amount is satisfied. When the sum of the current control amounts for the modules P_sum does not satisfy the total required control amount P_tot, the second controller 200 may generate and transmit an additional control command in a direction in which the error between the sum of the current control amounts for the modules P_sum and the total required control amount P_tot decreases.

For example, when a fuel cell module #3 becomes a command non-following state during the operation, the control target controllers controlling the remaining operable modules may assign the error between the total required control amount P_tot and the sum of the current control amounts P_sum, the number of operable fuel cell modules, and a correction amount (P_tot−P_sum)/5 according to the number of the command non-following modules to each corresponding fuel cell module 10.

In this case, as described above, the additional control command may include the slew rate, and the control target controllers receiving the additional control command may reflect the received slew rate to the individual control of each fuel cell module 10.

Next, FIG. 3 shows an example in which the control amount of each module 10 decreases as the total required control amount decreases during the operation. To mainly describe contents not overlapping the description made with reference to FIG. 2, as the total required control amount decreases P_tot→P_tot′, an error occurs between the sum of the current control amounts for the modules P_sum that follows the existing total required control amount P_tot and a new total required control amount P_tot′. In this case, the control target controllers perform individual control so that the control amount of each fuel cell module being operated is reduced by a correction amount (P_tot′−P_sum)/6 according to the additional control command of the second controller 200.

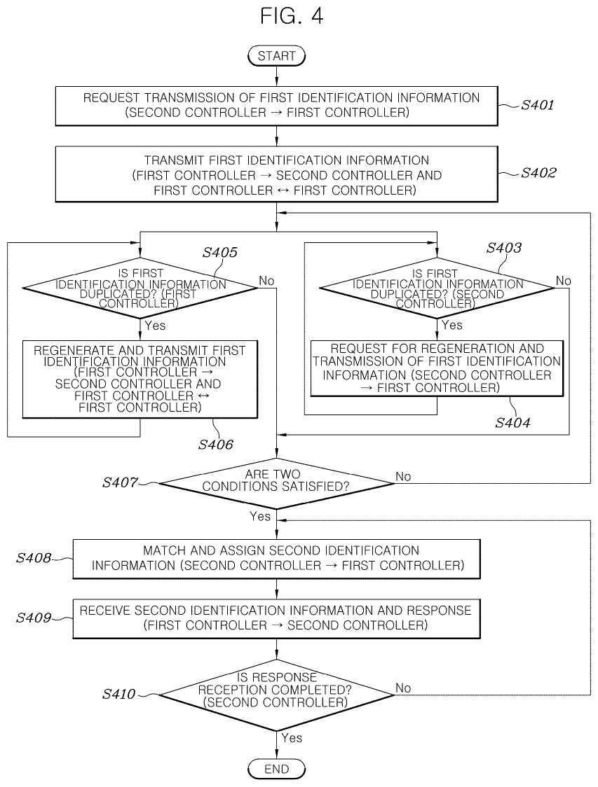

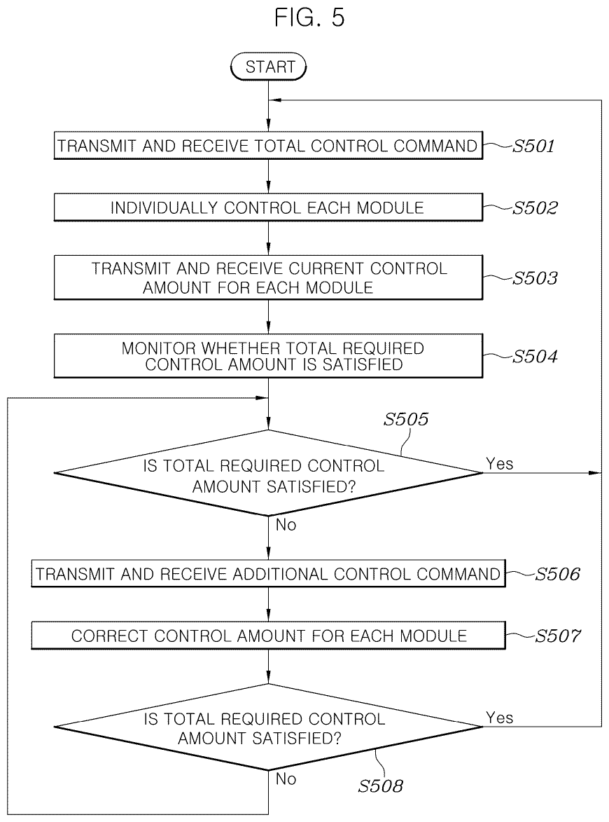

Hereinafter, a method of controlling a fuel cell system according to an embodiment of the present disclosure is described with reference to FIGS. 4 and 5.

FIG. 4 is a diagram (i.e., a flowchart) for describing a controller identification process according to an embodiment of the present disclosure.

Referring to FIG. 4, first, the second controller 200 requests transmission of first identification information to the plurality of first controllers 100 (an operation S401), and accordingly, each of the plurality of first controllers 100 generates and transmits the first identification information (an operation S402). In this case, the first identification information may be transmitted not only to the second controller 200, but also to different first controllers 100.

Thereafter, the second controller 200 determines whether the received first identification information is duplicated (an operation S403), and when duplication occurs (Yes in the operation S403), the second controller 200 requests the first controller 100 to regenerate and transmit the first identification information, thereby preventing duplicate identification (an operation S404).

Similarly, each first controller 100 may determine whether the first identification information is duplicated (an operation S405), and when duplication occurs (Yes in the operation S405), the first controllers 100 generating the duplicate first identification information regenerate and transmit the first identification information (an operation S406).

When both the first controller 100 and the second controller 200 determine that the first identification information is not duplicated (No in the operation 403, No in the operation 405, and Yes in an operation S407), the second controller 200 maps the first identification information and a location of each first controller 100, assigns unique second identification information to the mapping result, and then transmits the second identification information assigned to the mapping result to the first controller 100 (an operation S408).

The first controller 100 receiving the second identification information transmits a corresponding response back to the second controller 200 (an operation S409), and when the response is completed (Yes in an operation S410), the identification of the first controller 100 by the second controller 200 may be terminated.

FIG. 5 is a diagram (i.e., a flowchart) for describing an operation process of the plurality of fuel cell modules according to an embodiment of the present disclosure.

Referring to FIG. 5, a process is shown after the process of FIG. 4 is performed. First, the second controller 200 transmits a total control command including the total required control amount and the number of operable fuel cell modules 10 to the control target controllers (an operation S501), and the control target controllers receiving the total control command individually control corresponding fuel cell modules 10 (an operation S502).

During the individual control of each fuel cell module 10, the second controller 200 may receive the current control amount for each module from the control target controller (an operation S503) and monitor whether the sum of the current control amounts for the modules satisfies the total required control amount (an operation S504).

When the total required control amount is not satisfied as the monitoring result (No in an operation S505), the second controller 200 transmits an additional control command to the control target controllers (an operation S506), and the control target controllers receiving the additional control command correct a control amount for each module based on a correction amount according to the additional control command (an operation S507).

Despite the above process, when the total required control amount is not satisfied (No in an operation S508), the second controller and the control target controller repeat operations S505 to S508 to satisfy the total required control amount.

According to various embodiments of the present disclosure as described above, by controlling a plurality of fuel cell modules based on wireless communication between high-level and low-level controllers, mechanical constraints for wired connection between the controllers can be eliminated and costs can be reduced.

In addition, by controlling the fuel cell modules through the wireless communication, the arrangement and addition of the fuel cell modules becomes easier.

In addition, a control resource burden of the high-level controller can be reduced by assigning control to a plurality of low-level controllers.

The effects obtained by the present disclosure are not limited to the above-mentioned effects and other effects which are not mentioned can be clearly understood by those having ordinary skill in the art to which the present disclosure pertains from the above description.

As described above, although specific embodiments of the present disclosure have been described and illustrated, those having ordinary skill in the art should appreciate that various alternations and modifications are possible without departing from the technical spirit of the present disclosure as disclosed in the appended claims.

What is claimed is:

1. A fuel cell system, comprising:
a plurality of first controllers configured to control a plurality of fuel cell modules; and
a second controller configured to control the plurality of fuel cell modules through wireless communication with the plurality of first controllers,
wherein the second controller is further configured to transmit a total control command for satisfying a total required control amount of the plurality of fuel cell modules to at least one target controller among a plurality of identified first controllers based on a result of identifying the plurality of first controllers, and
wherein the at least one target controller is configured to individually control a corresponding fuel cell module, among the plurality of fuel cell modules, based on the total control command.

2. The fuel cell system of claim 1, wherein the corresponding fuel cell module is in a controllable state.

3. The fuel cell system of claim 1, wherein the total control command includes information of the total required control amount and a number of operable fuel cell modules among the plurality of fuel cell modules.

4. The fuel cell system of claim 3, wherein the second controller is further configured to determine the number of the operable fuel cell modules based on responses of the plurality of identified first controllers through wireless communication.

5. The fuel cell system of claim 3, wherein the target controller is further configured to perform the individual control to follow a target control amount for each of the plurality of fuel cell modules determined based on the total required control amount and the number of operable fuel cell modules.

6. The fuel cell system of claim 5, wherein the second controller is further configured to:
acquire a current control amount for each of the plurality of fuel cell modules from the at least one target controller, and
monitor whether the total required control amount is satisfied based on a sum of the acquired current control amounts of the plurality of fuel cell modules and the number of operable fuel cell modules.

7. The fuel cell system of claim 6, wherein when the total required control amount is not satisfied as the monitoring result, the second controller is further configured to transmit an additional control command, which includes an error between the sum of the current control amounts of the plurality of fuel cell modules and the total required control amount and the number of operable fuel cell modules, to the at least one target controller; and
wherein the at least one target controller is further configured to individually control the corresponding fuel cell module in response to the additional control command.

8. The fuel cell system of claim 7, wherein the at least one target controller is further configured to perform the individual control to follow a correction amount for each of the plurality of fuel cell modules determined based on the error between the sum of the current control amounts of the plurality of fuel cell modules and the total required control amount and the number of operable fuel cell modules.

9. The fuel cell system of claim 8, wherein the additional control command further includes information of a number of fuel cell modules not following the command among the plurality of fuel cell modules, the number of fuel cell modules not following the command is determined based on the target control amount of each fuel cell module and the current control amount of each module; and
the correction amount of each of the plurality of fuel cell modules is determined by further considering the number of fuel cell modules not following the command.

10. The fuel cell system of claim 7, wherein the additional control command further includes a slew rate determined based on the error between the sum of the current control amounts of the plurality of fuel cell modules and the total required control amount.

11. The fuel cell system of claim 10, wherein the slew rate is determined by further considering operating conditions of the plurality of fuel cell modules.

12. The fuel cell system of claim 1, wherein the second controller is further configured to:
receive first identification information arbitrarily generated from each of the plurality of first controllers, and
identify the plurality of first controllers by mapping the first identification information and a location of each of the plurality of first controllers generating the first identification information.

13. The fuel cell system of claim 12, wherein the second controller is further configured to:
transmit the mapping result to a first controller corresponding to the mapping result, and
perform identification of the plurality of first controllers based on a response from at least one first controller receiving the mapping result.

14. The fuel cell system of claim 12, wherein the second controller is further configured to provide second identification information with a unique value for each mapping result.

15. The fuel cell system of claim 12, wherein each of the plurality of first controllers is configured to transmit the first identification information, which is generated by itself, to remaining first controllers, and when at least one of the first identification information received from each of the remaining first controllers overlaps the first identification information which is generated by itself, the first identification information is regenerated.

16. The fuel cell system of claim 12, wherein, when overlapping first identification information is present in the received first identification information, the second controller is further configured to request retransmission to each of the first controllers transmitting the overlapping first identification information.

17. The fuel cell system of claim 12, wherein each of the plurality of first controllers is further configured to transmit first identification information, which is generated by itself, to remaining first controllers, and when at least one of the first identification information received from each of the remaining first controllers overlaps the first identification information which is generated by itself, the first identification information is regenerated; and
wherein when overlapping first identification information is present in the received first identification information, the second controller is further configured to request retransmission to each of the first controllers transmitting the overlapping first identification information.

18. The fuel cell system of claim 1, wherein the second controller is further configured to perform wireless communication by transmitting and receiving a signal to and from the plurality of first controllers through a frequency with a bandwidth that is greater than or equal to a preset range.

19. The fuel cell system of claim 18, wherein the second controller is further configured to determine a location of each of the plurality of first controllers based on a transmission and reception time of the signal.

20. A method of controlling a fuel cell system, comprising:
identifying, by a second controller, a plurality of first controllers through wireless communication with the plurality of first controllers configured to control a plurality of fuel cell modules;
transmitting, by the second controller, a total control command for satisfying a total required control amount of the plurality of fuel cell modules to at least one target controller among a plurality of identified first controllers based on a result of identifying the plurality of first controllers; and
individually controlling, by the at least one target controller, a corresponding fuel cell module among the plurality of fuel cell modules in response to the total control command.
